(19) United States
(12) Patent Application Publication
(10) Pub. No.: US 2009/0191309 A1
(43) Pub. Date: Jul. 30, 2009

(54) Process for recovering aroma from tea

(75) Inventors: Anudeep Rastogi, Bangalore (IN); Gurmeet Singh, Bangalore (IN)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc. d/b/a Unilever

(21) Appl. No.: 12/316,960

(22) Filed: Dec. 18, 2008

(30) Foreign Application Priority Data
Dec. 28, 2007 (IN) 2600/MUM/2007
Apr. 17, 2008 (EP) EP08154678

(51) Int. Cl. A23F 3/00; A23F 3/10; A23F 3/16

(52) U.S. Cl. 426/50; 426/386; 426/329; 426/52; 426/597; 426/655

(57) ABSTRACT

Disclosed is a process for recovering volatile aroma compounds from a tea material. The process comprises the steps of: generating aroma-laden vapours at a pressure of from 0.5 to 1.4 bar absolute from the tea material contacted with water or water vapours, and then condensing the aroma-laden vapours to recover aroma condensate. The process is controlled such that the mass of aroma condensate generated per unit dry mass of tea material is greater than 2 and the aroma-laden vapours comprise no more than 1% by weight entrained liquid.

### TECHNICAL FIELD

This invention relates to the processing of tea. It particularly relates to recovery of volatile aroma compounds from tea.

### BACKGROUND OF THE INVENTION

Any discussion of the prior art throughout the specification should in no way be considered as an admission that such prior art is widely known or forms part of the common general knowledge in the field.

Aroma is a major organoleptic quality parameter of tea. The aroma of tea has a significant impact on the consumer's choice of tea and the commercial valuation of tea. Therefore, the improvement of tea aroma is an ongoing subject of research.

A large amount of volatile aroma compounds are known to be lost during processing. Various methods such as steam stripping, solvent extraction, supercritical carbon dioxide extraction, etc. have been used to recover volatile aroma compounds during tea processing, which is sometimes then added back to a tea product.

Steam stripping is carried out at low temperature under vacuum (U.S. Pat. No. 4,130,669, 1978, Procter & Gamble) as it is believed that exposure to high temperature imparts off-flavours and causes deterioration in aroma quality. Operation under vacuum involves high cost and complexity.

One of the problems associated with the conventional steam-stripping aroma recovery process is that of degradation of volatile aroma compounds and/or reduction in their shelf life or stability.

Aroma condensate is typically subjected to a further step of concentration, by distillation, adsorption-desoprption or membrane-based separation. It is relatively difficult to carry out further concentration of aroma condensate in conventional steam-stripping processes without loss of quality and/or problems of fouling. Therefore, the aroma condensate needs to be added back to the tea immediately at the same processing site, thus reducing the flexibility of operation.

Further, the known methods do not afford flexibility of adding back aroma condensate to various types of tea without altering the taste characteristics.

It is known to carry out simultaneous extraction of soluble tea solids and aroma recovery from the tea leaves where the vapours during the extraction are condensed to recover volatile aroma compounds. Typically the duration of extraction is relatively small and the ratio of mass of aroma vapours condensed to dry mass of tea material is relatively small. Such processes generally give relatively low yield of aroma.

U.S. Pat. No. 3,997,685 (Procter & Gamble, 1976) discloses a process wherein the mass ratio of total vapours condensed to the dry mass of substrate is relatively large. However, a significant fraction of the total vapours condensed comprise non-volatile tea solids in the substrate material (termed as flavour concentrate in the patent). The ratio of mass of aroma vapours condensed to dry mass of tea material is relatively small.

In view of the limitations in the prior art, one of the objects of the present invention is to overcome or ameliorate at least one of the disadvantages of the prior art, or to provide a useful alternative.

It is an object of the present invention to provide a process for recovery of volatile aroma compounds that gives relatively high yield.

Another object of the present invention is to provide a process which yields volatile aroma compounds which are relatively more stable than those obtainable from known processes.

Another object of the present invention is to provide a process of recovery of volatile aroma compounds that is relatively cost-effective.

Another object of the present invention is to provide a process for recovery of volatile aroma compounds so that a tea product to which recovered aroma is added has consumer acceptable organoleptic properties.

Yet another object of the present invention is to provide a process for recovery of volatile aroma compounds at relatively high concentration such that the volatile aroma compounds can be transported across geographical locations offering flexibility in tea processing.

The present inventors have surprisingly found that by increasing the mass of condensed aroma-laden vapours per unit mass of tea material whilst reducing entrainment of non-volatile tea solids in the condensate, it is possible to obtain relatively high yields of volatile aroma compounds without compromising quality.

### SUMMARY OF THE INVENTION

According to the present invention there is provided a process for recovering volatile aroma compounds from a tea material comprising the steps of:
a) generating aroma-laden vapours at a pressure of from 0.5 to 1.4 bar absolute from the tea material contacted with water or water vapours; and
b) condensing the aroma-laden vapours to recover aroma condensate;
   characterized in that the mass of aroma condensate per unit dry mass of tea material is greater than 2 and the aroma-laden vapours comprise no more than 1% by weight entrained liquid.

According to another aspect, there are provided volatile aroma compounds obtainable by the process of the present invention.

According to yet another aspect, there is provided a tea composition comprising volatile aroma compounds prepared by the process of the present invention.

### DETAILED DESCRIPTION OF THE INVENTION

### Tea Material

Tea material that can be used in the process of the present invention includes any material obtained from the plant Camellia sinensis var. sinensis and/or Camellia sinensis var. assamica or derived therefrom after processing such a plant material.

The tea material can be selected from fresh tea leaf, green tea, black tea, tea fibre or a mixture thereof. Spent tea leaf, i.e. tea leaf that has been subjected to a prior step of extraction of soluble solids can also be used.

### Step (a)

The step (a) comprises generating aroma-laden vapours at a pressure of 0.5 to 1.4, more preferably from 0.7 to 1.4 and most preferably from 0.7 to 1.0 bar absolute from the tea material contacted with water or water vapours.

Step (a) is preferably carried out by one of the following steps:
i. by adding water to the tea material and subjecting the resulting mixture to evaporation; or
ii. by contacting the tea material with water vapour under distillation condition.

### Preferred Embodiments of Step (i)

Water is added to the tea material in the amount preferably from 10 to 50, more preferably from 10 to 30 and most preferably from 15 to 25 per unit dry mass of the tea material.

The resulting mixture is preferably subjected to evaporation at a temperature preferably from 70 to 110° C., more preferably from 80 to 105° C. and most preferably from 90 to 100° C.

The tea material is subjected to evaporation preferably in a batch or semi-batch mode. The evaporation may be carried out in any suitable evaporation equipment. The heat transfer may be direct or indirect. Indirect heating is provided by heat transfer medium without contacting the mixture. Indirect heating can be provided in various types of equipment such as jacketed vessels, or vessels provided with internal or external heating coils. The heating medium is preferably water, steam or thermic fluid. Direct heating can be provided by injection of steam into the mixture. Heating may also be provided by electrical means such as Ohmic heating or electroresistive heating elements.

During evaporation, the ratio of mass of the water to dry mass of the tea material is maintained at preferably from 10 to 50, more preferably from 10 to 30 and most preferably from 15 to 25. The ratio is maintained by replenishing the water that is evaporated. The water can be replenished periodically or continuously.

### Preferred Embodiments of Step (ii)

The tea material may be optionally wetted with water. The amount of water per unit dry mass of the tea material used for wetting is preferably from 0 to 5, more preferably from 1 to 4 and most preferably from 2 to 4.

The tea material, wetted or dry, is then contacted with water vapours under distillation condition. The amount of water vapour contacting with the mixture per unit dry mass of the tea material is preferably from 3 to 15, more preferably from 3 to 10 and most preferably from 3 to 8.

The water vapour is at a temperature preferably from 70 to 110° C., more preferably from 80 to 105° C. and most preferably from 90 to 100° C.

Any suitable equipment such as a packed bed can be used. The tea material is preferably supported on a porous plate or a mesh and acts as packing whilst the water vapours are passed through the bed in upward or downward direction. Although the water vapours may be in upflow or downflow configuration, it is particularly preferred that the water vapours flow vertically upwards through the packed bed of the tea material. it is believed that the liquid entrainment can be substantially reduced in the upflow configuration.

### Liquid Entrainment

The evaporation is preferably carried out in such a way as to reduce the entrainment of liquid in the aroma-laden vapours.

The present inventors have found that the entrainment of liquid in the aroma-laden vapours leads to an aroma condensate that comprises tea solids that are associated with deterioration of quality. Therefore, the process of the present invention is carried out so as to reduce entrainment of liquid in the aroma-laden vapours.

Accordingly, the aroma-laden vapours comprise no more than 1%, more preferably 0.5%, and most preferably 0.1% by weight entrained liquid. It is particularly preferred that the aroma-laden vapours are substantially free of the entrained liquid. It is believed that reducing or avoiding liquid entrainment in the aroma-laden vapours leads to reduction in contents of solids in the aroma condensate, which are related to deterioration of quality of aroma condensate.

As used herein, “entrained liquid” refers to the liquid phase carried over along with aroma-laden vapours. The entrained liquid may be in form of liquid droplets, mist or foam. Thus the aroma condensate will include entrained liquid and the condensed aroma-laden vapours unless entrained liquid is separated before the condensation.

The entrained liquid comprises water-soluble tea solids as it is in liquid form whilst the vapours are free of dissolved solids. Thus presence of water-soluble tea solids in the aroma condensate is indicative of liquid entrainment. A Brix meter can be used for measuring the amount of dissolved solids in an aroma condensate. The amount of entrained liquid is then easily calculated from the Brix measurement using equation 1 below:

Amount of liquid entrained(% w/w)=B.W/T.X (1)

wherein B is the Brix value of the condensate (i.e. % w/w soluble solids), T is the dry mass of tea material in step 1(a) (grams), X is fraction of water-soluble tea solids per unit mass of the dry tea material, and W is the mass of liquid water in contact with dry tea material in step 1(a) (grams). For example, if tea leaves having a dry mass of 100 g, wherein 30% of the dry mass is water soluble (i.e. X=0.3), are contacted with 2000 g of water to generate aroma-laden vapours which are condensed to recover a condensate having a Brix value of 0.15%, then the amount of entrained liquid in the aroma-laden vapours is 10%.

Preferably, an antifoam agent is added to the tea material prior to or during the step (a). The resulting reduction in foaming is believed to help in reducing liquid entrainment in the aroma-laden vapours.

Preferably a mechanical defoamer is used during the step (a). In step (i), the mechanical defoamer is used whilst subjecting the mixture of tea material with water to evaporation. Mechanical defoamer may be in form of a rotating stirrer above the liquid level that breaks the foam. Alternatively or additionally, mechanical defoamer may in form of an ultrasonic vibrator plate placed above the liquid level.

The resulting reduction in foaming due to the mechanical defoamer is believed to help in reducing liquid entrainment in the aroma-laden vapours.

### Liquid Entrainment Separator

Preferably, the aroma-laden vapours are passed through a liquid entrainment separator to separate the entrained liquid from aroma-laden vapours.

The liquid entrainment separator may be a part of the evaporator. Liquid entrainment can be reduced by using an evaporator with a large head space or vapour space. In practice, this can be achieved by reducing the ratio of working volume to the total volume of the evaporator. The ratio of working volume to the total volume of the evaporator is preferably below 0.7, more preferably below 0.6 and most preferably below 0.5.

The liquid entrainment separator can also be a separate apparatus. In particular, the liquid entrainment separator is preferably selected from a spacer column, impingement separator, baffle plates, cyclone separator, packed bed collector, wire mesh collector or combination thereof. A spacer column is a long vertical tube or pipe with the vapour-liquid mixture flowing vertically upwards.

### Step (b)

The aroma-laden vapours obtained in the step (a) are condensed to recover the aroma condensate.

Aroma-laden vapours include water vapour that originates from water/water vapour contacted with tea material and therefore the mass of aroma condensate per unit dry mass of tea material can be greater than the starting tea material. In fact the mass of the aroma condensate per unit dry mass of the tea material is preferably greater than 2, more preferably greater than 3, and most preferably greater than 5.

The mass of aroma condensate per unit dry mass of the tea material is preferably up to 10.

The aroma condensate comprises no more than preferably 0.1%, more preferably 0.05%, and most preferably 0.01% by weight of solids. The term “solids” as used herein means unevaporated solid residue after drying the condensate by evaporating liquid. The drying is typically carried out at a temperature of 100° C. for a period of 24 hours.

The condensate recovery rate or the mass of condensate recovered per unit dry mass of the tea material per hour is preferably from 0.1 to 10, more preferably from 0.2 to 4 and most preferably from 0.5 to 2.

The step of condensing aroma-laden vapours can be carried out in any suitable equipment. Examples of suitable equipment include, but are not limited to, shell and tube or double pipe heat exchangers. The heat exchanger is preferably vertically mounted.

The aroma-laden vapours are preferably on the tube side whilst the cooling fluid is on the shell side or on the annulus side.

### Pretreatment of the Tea Material

According to a preferred aspect, the process preferably comprises a step of enzymatic pre-treatment of the tea material prior to the step (a). The process preferably comprises a step of incubating the tea material in an aqueous medium comprising an enzyme selected from cellulase, pectinase, amylase, β-glucosidase, primverosidase or a mixture thereof, prior to the step (a). It is particularly preferred that the enzyme is selected from pectinase, β-glucosidase, primverosidase or a mixture thereof.

The term cellulase refers to a class of enzymes produced chiefly by fungi, bacteria, and protozoans that catalyze the cellulolysis (or hydrolysis of cellulose). However, there are also cellulases produced by other types of organisms such as plants and animals. Several different kinds of cellulases are known, which differ structurally and mechanistically. The EC number for this group of enzymes is EC 3.2.1.4. Some commercially available enzymes of this class include CELLULASE AP® (Amano Enzymes, Inc.) and VISCOFERM® (Novozyme).

The active cellulase content of an enzyme is measured as enzyme activity on carboxymethyl cellulose (CMC) and expressed as carboxymethyl cellulose units, abbreviated as CMCU according to the standard practice in the field. The term CMCU refers to picomoles of glucose formed per minute using carboxymethyl cellulose as substrate and cellulase enzyme under standardized conditions. The protocol for estimation of CMCU is described by Lever (Analytical Biochemistry 47, 273-279, 1972).

The activity of the cellulase is preferably from 10⁵ to 10⁷, more preferably from 5×10⁵ to 5×10⁶, and most preferably from 5×10⁵ to 2×10⁶ CMCU per kg dry mass of the tea material.

The term pectinase refers to enzymes that break down pectin, a polysaccharide substrate that is found in the cell walls of plants. Pectinase can be extracted from fungi such as Aspergillus niger. Some commercially available enzymes of this class include VISCOZYME® (Novozyme) and EXTRACTASE® (Advanced Enzyme Technologies).

The activity of pectinase enzyme is measured in terms of Apple Juice Depectinase Units, commonly abbreviated as AJDU. It is based on the time required to depectinase an unclarified apple juice substrate at pH 3.5 and 45° C. The end point is determined by isopropyl alcohol precipitation. Activity is then determined by correlating depectinization time to the unknown sample with that of a pectinase standard of known activity using a defined single strength apple juice substrate according to procedure number 400.16 (dated May 22, 1992) of Solvay Enzymes, USA. Details are given in U.S. Pat. No. 6,132,727 (Rohde et al, 2000) which is incorporated herein by reference.

The activity of the pectinase is preferably from 10⁴ to 10⁷, more preferably from 0.5×10⁵ to 5×10⁶, and most preferably from 0.5×10⁵ to 2×10⁶ AJDU per kg dry mass of the tea material.

The tea material may be optionally wetted with water prior to addition of the aqueous medium to the tea material.

The ratio of the mass of water to the dry mass of the tea material during the step of incubating is preferably from 2:1 to 12:1, more preferably from 2:1 to 8:1, and most preferably from 3:1 to 6:1.

The step of incubating is for a period of preferably 5 to 200 minutes, more preferably from 15 to 150 minutes and most preferably from 30 to 90 minutes.

The step of incubating is at temperature between from preferably 5 and 70° C., more preferably between 15 and 60° C., and most preferably between 25 and 60° C.

It is preferred that the tea material is subjected to mixing during the step of incubating. The mixing may be intermittent or throughout the duration of incubation. Mixing may, for example, be by means of an impeller attached to a rotating arm or by rotating the container to achieve mixing by tumbling of the contents.

### Concentration of Aroma Condensate

According to a preferred aspect, the aroma condensate obtained at the end of step (b) may be further concentrated. The concentration of aroma condensate can be carried out by distillation, adsorption-desorption, and/or by membrane separation processes such as pervaporation and/or reverse osmosis.

### Distillation

The aroma condensate is preferably subjected to distillation to separate the concentrated aroma from the condensate. It will be appreciated that aroma condensate that comprises less than 0.1% by weight solids allows distillation at relatively high temperature without causing deterioration in quality of aroma.

### Adsorption-Desorption

In adsorption-desorption, the aroma condensate is contacted with adsorbents such as activated carbon, zeolites, or polystyrene-divinyl benzene resins for selective adsorption of the aroma components whilst the relatively aroma-free water is discarded. Subsequently, steam, hot water, organic solvents or a supercritical fluid such as carbon dioxide is contacted with the aroma-laden adsorbent to recover the concentrated aroma. It will be appreciated that the aroma condensate comprising less than 0.1% by weight solids allows for concentration of aroma without causing contamination of adsorbent and/or the medium used for desorption.

### Membrane Separation

Pervaporation or reverse osmosis can be used for concentration of aroma. It will be appreciated that the aroma condensate comprising less than 0.1% by weight of solids allows concentration of aroma whilst substantially reducing the fouling of membranes.

### Aroma Add-Back

Recovered aroma condensate, or further concentrated aroma condensate can be added to tea products to enhance aroma. Aroma condensate may be sprayed onto a leaf tea product, instant tea product or a ready to drink product. A drying step may be required for leaf tea and instant tea to bring the moisture content down to stabilize the final product subsequent to aroma add-back.

The steps of drying can be carried out, for example, by using equipment such as fluid bed dryer, tray dryer, vacuum dryer and/or freeze dryer for leaf tea and spray dryer, thin film dryer and/or freeze dryer for instant tea.

### EXAMPLES

The invention will now be demonstrated with examples. The examples are by way of illustration only and do not limit the scope of the invention in any manner.

### Example 1

109.8 g of high grown Sri Lankan tea broken mixed fannings having moisture content of 8%, was taken into a round bottom flask. 2000 mL water was added. The resulting mixture was slurried with the mass of water per unit dry mass of tea material being about 20. The slurry was heated to induce boiling of the liquid at 1 bar absolute pressure. The aroma-laden vapours were passed through a liquid entrainment separator before passing them through the condenser. The liquid entrainment separator was a vertical column of 1 meter length wherein the aroma-laden vapours flowed in vertically upward direction allowing entrained liquid droplets, if any, to condense on the wall and flow back into the evaporator, thus preventing any entrained liquid from reaching the condenser. The rate of vapour generation was maintained at approximately 100 g/hour. The aroma-laden vapours were condensed by passing through a condenser operating on a cooling utility at 25° C. A total of 600 mL condensate was collected after 6 hours.

### Evaluation of Quantity, Quality and Stability of Aroma

The total organic carbon in the aroma condensate was measured using a Shimadzu TOC analyzer-5000A. A higher value of total organic carbon is indicative of higher concentration of aroma compounds in the aroma condensate and therefore, of higher quantity of aroma.

The solids content in the aroma condensate were measured gravimetrically as follows. 50 mL of aroma condensate was weighed and dried in oven at 100° C. for 24 hours. The amount of solid residue was weighed to calculate % solids by weight in the aroma condensate.

Colour is indicative of quality of aroma condensate. Colourless aroma condensate can be blended or added back in various types of tea. Further the colourless aroma condensate indicates absence of solids so that the aroma condensate can be further concentrated in a relatively easy manner. Pale brown or any other colour of aroma condensate indicates presence of solids that can have deleterious effect on the quality of aroma condensate.

Stability of aroma condensate was measured as follows: Phenyl acetaldehyde, a key component of tea aroma, was used as a marker compound. Amount of phenyl acetaldehyde in the aroma condensate was measured by gas chromatography at t=0 (initial) immediately after the condensation. The aroma condensate was kept at 25° C. for 48 hours and the final amount of phenyl acetaldehyde was measured (t=48 hours). The ratio of final to initial amount of phenyl acetaldehyde is a measure of aroma stability, with a lower ratio indicating a more unstable aroma whilst a higher ratio indicates a more stable aroma

### Example 1-A

The process of example 1-A was same as the process of example 1, except that the condensate was collected over 15 minutes.

### Example 1-B

The process of comparative example 1-B was similar to the process of example 1 in all respects, except that the aroma-laden vapours were directly passed from the evaporator to the condenser, without using the liquid entrainment separator. From material balance, it was established that the aroma-laden vapours comprised greater than 1% by weight entrained liquid. Water soluble solids were 0.15% by weight in the aroma condensate.

### Example 1-C

The process of comparative example 1-C was similar to the process of example 1 in all respects, except that the evaporation was carried out a pressure of 0.18 bar absolute.

### Example 2

### The Effect of Enzymatic Pre-Treatment of the Tea Material

The tea material of the Example 1 was pretreated with pectinase enzyme prior to the step (a). The tea material was wetted with an aqueous medium comprising pectinase (obtained from Advanced Enzyme Technologies, India). The activity of the pectinase was 10⁶ AJDU (Apple Juice Depectinase Units) per kilogram dry mass of the tea material. The wetted tea material was incubated at 55° C. for 60 minutes. The incubated tea material was then subjected to all the steps as described in Example 1.

The results are given in Tables 1 and 2.

TABLE 1

| | | | | Aroma |
|---|---|---|---|---|
| | | Water-soluble | | condensate |
| | Liquid | tea solids in | | (kg/kg dry |
| Ex | entrainment | condensate (% | Pressure | mass of |
| No | separator | by mass) | (bar abs) | tea) |
| 1 | Yes | 0 | 1 | 5.94 |
| 1-A | Yes | 0 | 1 | 0.16 |
| 1-B | No | 0.15 | 1 | 5.94 |
| 1-C | Yes | 0 | 0.18 | 6.78 |
| 2 | Yes | 0 | 1 | 6.0 |

TABLE 2

| | | The ratio of final | |
|---|---|---|---|
| | Total organic | (t = 48 hours) to | |
| | carbon (mg/kg | initial (t = 0) | |
| Ex | dry mass of | amount of phenyl | |
| No | tea) | acetaldehyde | Colour |
| 1 | 472 | 1 | Colourless |
| 1-A | 70.75 | 1 | Colourless |
| 1-B | 472* | 0.4 | Pale Brown |
| 1-C | 64.15 | 1 | Colourless |
| 2 | 1323 | 1 | Colourless |

*Total organic carbon of volatile components of aroma

It is clear that the process of the present invention (Example 1) provides an aroma condensate in high yield (472 mg/kg dry mass of tea material), which is of good quality and stability.

In the process of comparative example 1-A, the resulting quantity of aroma was found to be significantly less as compared to that obtained by the process of Example 1.

In the process of comparative example 1-B, although the amount of aroma condensate obtained was relatively high, the quality was not acceptable as the colour of aroma condensate obtained was pale brown. Further, the aroma condensate was relatively unstable as indicated by degradation of phenyl acetaldehyde.

In the process of comparative example 1-C, the amount of total organic carbon in the aroma condensate was found to be significantly less than that in the aroma condensate obtained by the process of the Example 1.

From the results of Example 2, it is clear that the process with the enzymatic pre-treatment provides an aroma condensate with a further significant enhancement in yield, without compromising quality and stability characteristics.

It will be appreciated that the process of the present invention provides relatively high yield of volatile aroma compounds at relatively high concentration in the aroma condensate without compromising on stability in a relatively cost-effective manner.

1. A process for recovering volatile aroma compounds from a tea material comprising the steps of:
a) generating aroma-laden vapours at a pressure of from 0.5 to 1.4 bar absolute from the tea material contacted with water or water vapours, and;
b) condensing the aroma-laden vapours to recover aroma condensate;
characterized in that the mass of aroma condensate per unit dry mass of tea material is greater than 2 and the aroma-laden vapours comprise no more than 1% by weight entrained liquid.

2. A process as claimed in claim 1 wherein the aroma condensate comprises no more than 0.1% of solids by weight.

3. A process as claimed in claim 1 wherein the aroma-laden vapours are passed through a liquid entrainment separator prior to the step (b) to separate the entrained liquid from aroma-laden vapours.

4. A process as claimed in claim 1 wherein an antifoam agent is added to the tea material prior to or during the step (a).

5. A process as claimed in claim 1 wherein a mechanical defoamer is used during the step (a).

6. A process as claimed in claim 1 wherein the mass of the aroma condensate generated per unit dry mass of tea material per hour is from 0.1 to 10.

7. A process as claimed in claim 1 comprising a step of incubating the tea material in an aqueous medium comprising an enzyme selected from cellulase, pectinase, amylase, β-glucosidase, primverosidase or mixture thereof, prior to the step (a).

8. A mixture of volatile aroma compounds prepared by the process as claimed in claim 1.

9. A tea composition comprising the mixture of volatile aroma compounds as claimed in claim 8.
